(19) United States
(12) Patent Application Publication
(10) Pub. No.: US 2012/0116912 A1
(43) Pub. Date: May 10, 2012

(54) METHOD AND SYSTEM USING A SECURE COMPUTER NETWORK FOR MATCHING CUSTOMERS AND VENDORS

(76) Inventor: Mark B. Moran, Aviston, IL (US)

(21) Appl. No.: 13/290,933

(22) Filed: Nov. 7, 2011

Related U.S. Application Data
(60) Provisional application No. 61/456,418, filed on Nov. 5, 2010.
(60) Provisional application No. 61/574,447, filed on Aug. 3, 2011.
(60) Provisional application No. 61/555,371, filed on Nov. 3, 2011.
(60) Provisional application No. 61/555,374, filed on Nov. 3, 2011.

(51) Int. Cl. G06Q 30/02

(52) U.S. Cl. 705/26.4

(57) ABSTRACT

A secure computer network, competitive offer system, and associated methods for facilitating the exchange of confidential information between service vendors and consumers with a reasonable expectation of privacy. In an embodiment, the methods and systems comprise using a secure computer network for facilitating the exchange of confidential information between vendors and consumer in service or service/good hybrid industries.

### CROSS REFERENCE TO RELATED APPLICATION(S)

This application claims the benefit of and priority to U.S. Provisional Patent Application Ser. No. 61/456,418, filed Nov. 5, 2010; U.S. Provisional Patent Application Ser. No. 61/574,447, filed Aug. 3, 2011; U.S. Provisional Patent Application Ser. No. 61/555,371, filed Nov. 3, 2011; and U.S. Provisional Patent Application Ser. No. 61/555,374, filed Nov. 3, 2011. The entire disclosure of all the above applications is incorporated herein by reference.

### BACKGROUND

1. Field of the Invention

The present invention relates to methods and systems which utilize a secure computer network providing a reasonable expectation of privacy so a vendor to make an open competitive offer which can be changed by the vendor at will but which the vendor agrees to honor with a consumer who receives the offer in response to a query through the network.

2. Description of the Related Art

The Internet has had a profound impact on brick and mortar businesses selling goods. Price and quality information is readily available to consumers of goods. There are even websites and mobile applications whose purpose is to seek out the best prices on specific goods and direct consumers to the retailers of those goods (whether Internet or brick and mortar retailers). Because of this ready availability of price information, the Internet has caused a downward pressure on prices for goods as one can no longer rely on a lack of information to make sales at a higher price.

Just as the Internet has affected the price of goods, the Internet can affect the price of services and the price of products which include a service component. This is clearly evident in the highly regulated stock brokerage industry where the Internet caused a revolutionary change in the structure of stock brokerage firms caused by consumer demand for transparency in fees charged. A result of combining the information transparency of the Internet with financial products and stock brokerages is the present discount stock brokerage industry which in many respects allows a stock buyer to purchase the goods they desire (stocks) without utilizing a traditional broker at all. Presently, there is high consumer demand for transparency technology that immediately offers the true price to consumers, who, enabled with current information, may thereby make important decisions about purchasing services such as an attorney, a real estate agent, an eye surgeon, a bricklayer or the like.

What the consumer generally wants from a service provider is good value where value is economically recognized as a combination of quality and price. One problem in comparing a service provider's value with another's, however, is that value is generally recognized as being a function of the each consumer's unique, subjective assessment of the quality of a vendor as it relates to the cost of a vendor. Two different service vendors at widely different price points, can offer similar value to one consumer while having widely different value to a second consumer.

Therefore, the determination of value is necessarily subjective and involves consideration of subjective variables. Because the quality of service vendors or service-combined-with-product vendors generally cannot be accurately predicted at the time the consumer is shopping for a vendor, cost often becomes much more important prior to the consumer hiring a vendor and in the consumer making an initial evaluation of vendors based on an initial offer.

At the time the consumer is shopping for a vendor, the consumer has a heightened focus on cost, which allows the consumer to arrive at a subjective, preliminary perception of value, in the context of cost's relation to quality, or in the instance of a service coupled with a commodity (i.e. a bricklayer), cost's relation to quantity (i.e. Cost/Gallon of gasoline or Cost/square foot of reinforced concrete poured four inches thick). This preliminary perception, however, is often inaccurate and it is only after the time the consumer learns the associated cost and the consumer makes a preliminary assessment of quality for a particular vendor, that the consumer can then assign what the consumer can use as a probable value for each of the prospective vendors whom the consumer is considering hiring.

Print advertisements, referrals, and rating services such as Angie's List are offered on the Internet in order to give the consumer a preliminary perception of value by providing the consumer with a quantified, objective rating about the quality of a service provider to help them make an initial value determination, but price is usually not disclosed in conjunction with these systems and these systems often cannot balance for price. Thus, the various ratings can obscure the relative price differences between otherwise equal service providers.

Service vendors are often reluctant to publish price information because circumstances of providing services may change and, given the profound shortcomings of non-electronic, non-digital media, there is no easy way for a vendor to update or withdraw a published offer. As a simple example, since services tend to be much more reliant on the time available to the person providing them as opposed to goods which can be mass produced, the price a service provider will offer may be dependent on how much other work they already have.

Hence, whether the consumer needs to have a retaining wall built or legal matter attended to, the consumer must endure inconvenience and make a call and/or meet with the vendor to discuss the service needed before cost, which is the second half of the value equation, is revealed. Further, the consumer also needs to do their own research, relying on the perceived value of a particular type of rating in order to obtain the first half of the value determination. Comparing vendor offers side-by-side and identifying which is best value is, therefore, a time consuming and not effectively done activity.

Still further, many “objective” evaluations have a necessary bias (for example, the fact that people are more likely to post a negative experience than a positive one), and evaluations based on advertising in telephone directories, newspapers, radio, television and the Internet in static ads that cannot be changed quickly in response to market forces are intended to be biased in order to create initial contacts with resolution of actual value occurring later.

Because service prices presently are not readily available and are not connected with rating information, there is a lack of competition in most service industries. As a narrow example, in the personal injury legal services industry, wholesale advertising is done by firms who routinely refer clients, so-called brokering, to other firms on payment of a referral fee. This practice is characterized as wholesale advertising because a relatively large percentage of the money recovered on behalf of the personal injury client is paid by the referred attorney to the referring attorney as a type of finder's fee for performing the simple act of sending a personal injury client to the referred attorney who represents the injury client. Thus, the referring attorney has an incentive to obtain a large number of initial inquiries (which can often be obtained through intense marketing efforts).

If the referred attorney receives a typical ⅓ of the recovered amount, it is customary for the referring attorney to receive ⅓ of the ⅓ or 11%. If the referred attorney raises his fee to 50% of the recovered amount, the referring attorney could receive 50% of the 50% contingent fee earned by the referred attorney, or 25% of the gross monies collected on behalf of the personal injury client. As an example, in the context of a personal injury case settlement in the amount of $100,000.00, the referring attorney earns a referral fee of $25,000.00 for merely picking up a telephone to send the client (who may have found them solely based on a marketing campaign) to a different attorney.

Continuing in the example, many personal injury clients are in an uneven bargaining position with attorneys because they lack knowledge about the system or negotiating skills to bargain with lawyers over the cost of their legal services. Similarly, their ability to determine an attorney's skill, or the complexity of their case, is often above their skills as well since they often have a very limited understanding of the legal system, their rights in their type of case, and what outcome will be obtained by a “good” or “bad” attorney.

This problem is further compounded in certain services industries, such as, but not limited to law and medicine, where outcomes involve some degree of uncertainty. As opposed to services where the outcome is more determinable ahead of time, the ultimate outcome in these industries is dependent both on the skill of the practitioner as well as some degree of luck.

Because of this interaction of skill and luck, these types of service industries are often heavily regulated. Basically, a regulatory agency which considers itself to have a high understanding of the skill necessary to be “good” at practicing in the area sets requirements for those who intend to provide the services. Thus, the consumer is not required to understand or fully appreciate the value provided as those service providers as the bottom end of the spectrum of quality are denied license to provide the services and, thus, the consumer is supposedly assured with a certain adequate level of service.

Accordingly, attorneys and others in more regulated professions have often been allowed (if not encouraged) to conduct business in an environment that is not adequately competitive. This has resulted in profound economic inefficiencies and inequities suffered by consumers of these services. In effect, the action by the regulators to provide an “adequate” level of service at a “sufficient” value has resulted in a push for all in that service to provide only the same “sufficient” level of value, and therefore price often becomes a default determiner. A more expensive attorney is often expected to be better simply because s/he is more expensive. Similarly, there is a push by attorney's to charge similar rates regardless of quality because such rates are expected by clients. These two factors have resulted in a disconnect between price and quality in the legal field and a bunching of legal pricing where many poor practitioners are dramatically overpaid while excellent practitioners are underpaid for the various services they perform.

A quick look at a local telephone directory shows that there are many personal injury attorney advertisements but legal fee rates are not commonly advertised. Part of this is because the fee of 33% is fairly universal. However, there is also no convenient system that a consumer can use to locate attorneys who will offer competitive, contingent, net contingent, hourly and flat fee rates made possible by the removal of expensive, such as, but not limited to, unnecessary wholesale advertising referral fees. Nor is there a way for attorneys to openly compete with other attorneys on the basis of quality and price thereby providing consumers optimal value in legal services. Instead, powerful marketing efforts are often rewarded with increased fees regardless of the quality (or value) provided.

### SUMMARY

Because of these and other problems known to those of ordinary skill in the art there has been no method or system for an exchange of confidential pricing information over the Internet between a consumer and a vendor of a service/product for facilitating the consumer's selection of a vendor offering the subjective best value—the consumer's best combination of quality and price for each consumer's unique subjective assessment of value. A consumer's or vendor's reasonable expectation of privacy requires consumer and transactional information to be securely protected throughout all of the communications, and especially so in the context of the attorney-client relationship or other relationship where disclosure needs to be confidential to protect the ability of the consumer to work with the vendor freely. Standard methods of disclosure of information over the Internet do not satisfy that requirement because the information can be intercepted. For that reason the use of the Internet for the exchange of confidential information necessary to evaluate the needs of a consumer and make an offer has been inhibited and many offer situations are confined to in-person meetings.

In light of the above, described herein, among other things, is a secure computer network, competitive offer system, and associated methods for facilitating the exchange of confidential information between vendors and consumers with a reasonable expectation of privacy. In an embodiment, the methods and systems comprise using a secure computer network for facilitating the exchange of confidential information between vendors and consumer in service or service/good hybrid industries.

In an embodiment, the method and system includes a secure computer network having a database associated with a web site for consumers to request offers by vendors of products that include a service component, such as professional service providers for particular services. The terms of the offers are changeable by the vendors as participants in a continuously competitive marketplace and in accordance with specifics of the services requested. The offers by competing vendors are centralized on the database of the secure server associated with the web site and precede a prospective consumer's querying and posting of needs. The secure network further allows the posting of the needs of a potential consumer or client for professional services and automatically generates the specifics of a vendor's offer based on the consumer's desired service and information provided to the vendor indicating how the server should “bid” an offer. Offers are provided in a date and time stamped offer report of matches along with other information that may be useful in the consumer's determination of value. The report generally includes a unique identifier to verify validity. The report may be reviewed by the vendors listed in the report and by the consumers. The vendors are committed to render the services on terms no less favorable than offered on the date stamped report or decline representation (i.e., no bait and switch). The report allows the consumer to immediately compare relevant, contextual offers and promotes competition among the vendors who can see the offers of other vendors for the same goods or services.

The vendor offers as posted in the report represent the highest price, cost or rate the consumer will be charged, with the vendor reserving the right to lower the vendor's price or decline the case or work after the vendor has received more detailed information about the consumers needs or situation.

Described herein, among other things, is a computerized method of matching service vendors to consumers seeking services, the method comprising: providing a computer server having access to a secure database and accessible via a computer network; securely connecting a plurality of vendors to the network to allow the vendors to provide vendor information which may be used to form an offer by each vendor to provide certain services, the vendor information being changeable on the secure database by the providing vendor at any time; securely connecting a consumer to the network for requesting a desired service; and the server generating an offer report based on the desired service and the vendor information, the offer report comprising a plurality of offers of services by at least one of the vendors; wherein the offer report is date stamped, identifies each of the at least one vendors, and provides a price for the desired service; wherein the price is specific to the desired service of the consumer; and wherein each of the vendors listed in the offer report is bound, as a condition to being allowed to access the server, that each of the vendors will provide the desired service for no more than the price or will decline to provide the desired service.

In an embodiment of the method, the vendor must make contract with the consumer or decline within a preset period of time.

In an embodiment of the method, the server provides the offer report to all the vendors identified in the report for competitive review of the offers therein.

In an embodiment the method further comprises: allowing the consumer to select at least one vendor in the offer report; and the server providing the offer report to all the selected vendors to allow each of the selected vendors to provide a new competitive offer. The consumer may provide additional information about the desired service to the selected vendors and/or the consumer can select one of the new competitive offers and contract with the vendor providing the offer via the server.

There is also described herein a system of matching service vendors to consumers seeking services comprising: a computer server accessible via a computer network; a secure connection between the server and a plurality of vendors over the network to allow the vendors to provide vendor information to the server which may be used to form an offer by each vendor to provide certain services; the vendor information being changeable on a secure database associated with the secure server by the providing vendor at any time; and a secure connection between the server and a consumer over the network allowing the consumer to indicate a desired service; wherein the server generates an offer report based on the desired service and the vendor information, the offer report comprising a plurality of offers of services by at least one of the vendors and provides access to the offer report to the consumer; wherein the offer report is date stamped, identifies each of the at least one vendors, and provides a price for the desired service; wherein the price is specific to the desired service of the consumer; and wherein each of the vendors listed in the offer report is bound, as a condition to being allowed to access the server, that each of the vendors will provide the desired service for no more than the price or will decline to provide the desired service.

In an embodiment of the system, the vendor must make contract with the consumer or decline within a preset period of time.

In an embodiment of the system, the server provides the offer report to all the vendors identified in the report for competitive review of the offers therein.

In an embodiment the system further allows the consumer to select at least one vendor in the offer report; and the server provides the offer report to all the selected vendors to allow each of the selected vendors to provide a new competitive offer. The consumer may provide additional information about the desired service to the selected vendors and/or the consumer can select one of the new competitive offers and contract with the vendor providing the offer via the server.

There is also described herein a non-transitory computer readable memory comprising: computer readable instructions for providing a computer server having access to a secure database and accessible via a computer network; computer readable instructions for securely connecting a plurality of vendors to the network to allow the vendors to provide vendor information which may be used to form an offer by each vendor to provide certain services; the vendor information being changeable on the secure database by the providing vendor at any time; computer readable instructions for securely connecting a consumer to the network for requesting a desired service; and computer readable instructions for the server generating an offer report based on the desired service and the vendor information, the offer report comprising a plurality of offers of services by at least one of the vendors; wherein the offer report is date stamped, identifies each of the at least one vendors, and provides a price for the desired service; wherein the price is specific to the desired service of the consumer; and wherein each of the vendors listed in the offer report is bound, as a condition to being allowed to access the server, that each of the vendors will provide the desired service for no more than the price or will decline to provide the desired service.

### BRIEF DESCRIPTION OF THE FIGURES

FIG. 1 is a block diagram of a secure computer network forming an embodiment of the present system.

FIG. 2 is a block diagram of one embodiment of the secure computer connection including an authentication module in the server and a remote user.

FIG. 3 is a flow chart of functions accessible through a vendor's home page on the secure network.

FIG. 4 is a flow chart of functions accessible through a consumer's home page on the secure network.

FIG. 5 is a flow chart showing the results of a consumer's query for vendor biographies.

FIG. 6 is a report generated in response to a consumer's query as to attorneys willing to take a case involving an auto vehicle accident in Missouri.

FIG. 7 is a screen shot showing fields for data entry in conjunction with a recovery calculator module.

### DETAILED DESCRIPTION OF THE PREFERRED EMBODIMENT(S)

The system (10) described herein generally comprises a secure computer network which serves to provide offers by vendors to perform certain services requested by a consumer. The offers are preliminary, but are in the form of a binding offer to perform the services at a price no higher than that indicated. Offers are generated based on various variables in the desired service. Specifically, a plurality of vendors will enter specifics of how they will price particular services based on the variables. These variables can include the size of the job (for example the number of feet of concrete to be laid), the nature of the job (is this concrete for a patio or a driveway), the timing of the job (next 30 days, 60 days from now), the distance to the job (is this 3 miles or 3000 miles from the vendor's office), the difficulty of the job (is the concrete on a hill or a flat surface), and any other factors that may be relevant and can be handled by the server. In many cases, the list of variables is relatively small and only general type and location of the job will be used. It should be recognized that vendor's offers are expected to potentially change based on the variables (e.g. they will charge a higher “per foot” rate to lay concrete on a steep slope than a flat plane) and may interact with each other (the same vendor may charge a reduced “per foot” rate for a bigger job).

A consumer then enters the specifics of the service they wish to have performed into the same server. Based on the specifics of the requested service, the server will access the information provided by the vendors and generate a list of vendors who are interested in performing the desired service, and will then report their price based on the above variables. Thus, for the consumer's specific desired service, the computer will take into account all the entered vendor information, run all interrelationships, and return a price quote from that vendor.

The output of this calculation is called an offer report and will include prices for a plurality of vendors who are willing to perform the services. The offers contained in the offer report will be specific to the desired services and to the specific time at which the report is generated. Thus, it is a “snapshot” of offers available (and now “locked”) at that instant. From this offer report, the consumer may accept an offer, or may enter into a further competitive “bid auction” where the vendors are allowed to modify their offers after reviewing more specifics of the services (generally those that cannot be easily put into the automated calculation by the server) to get more competitive bids.

It is important to recognize that what an embodiment of the system is designed to do is to eliminate the need of a consumer to contact multiple service providers on their own, over time, in order to obtain comparative cost information for the performance of a particular service. Instead, the offer report provides an automated fixed indicator of offers for that service at the particular instant. The system then allows for further refinement upon entry of additional details.

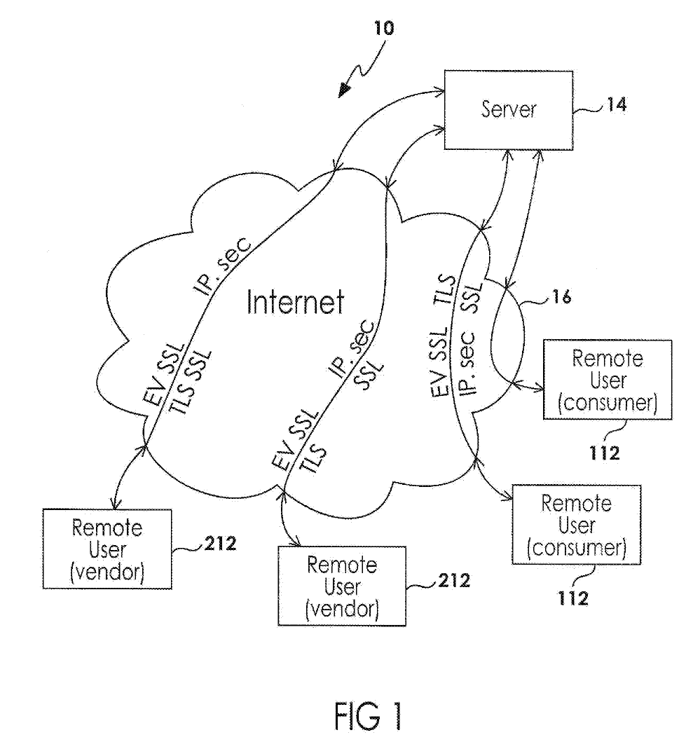

Referring to the drawings more particularly by reference number, FIG. 1 provides an embodiment of a system (10) which is a secure computer network including a plurality of remote users and a server computer (14). The users comprise either consumer users (112) that are interested in purchasing services or vendor users (212) that are interested in providing them. In some cases, it is possible for a user to be a consumer (112) for one transaction and a vendor (212) for a different one.

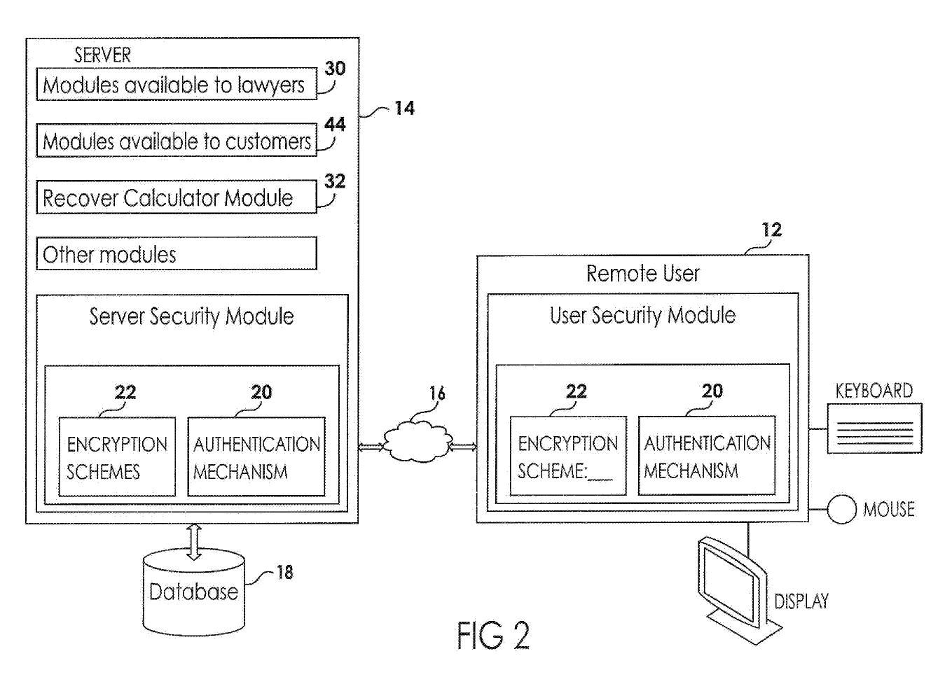

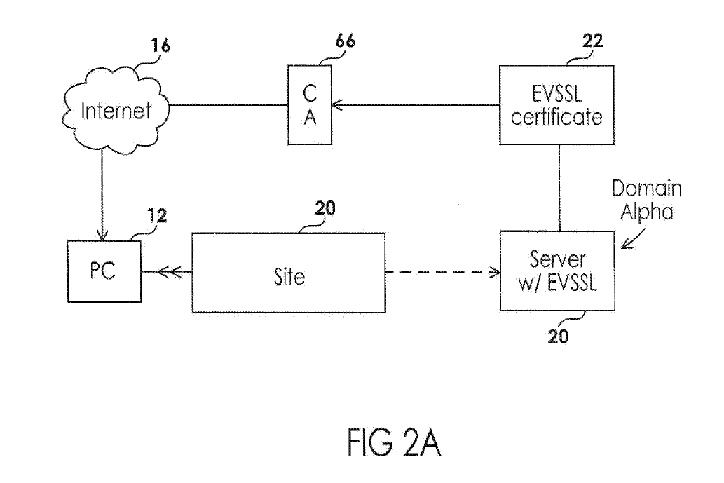

As shown in FIG. 2, users (12) (which generally comprise both vendor's (212) and consumers (112)) may connect to server (14) through the a network (16), such as, but not limited to the Internet, by means of a user computer. Throughout this disclosure, the term “computer” will be used to describe hardware which implements functionality of various systems. The term “computer” is not intended to be limited to any type of computing device but is intended to be inclusive of all machine-based computational devices including, but not limited to, processing devices or processors, personal computers, work stations, servers, clients, portable computers, and hand held computers such as, but not limited to, palmtop devices and Smartphones. Further, each computer discussed herein is necessarily an abstraction of a single machine. It is known to those of ordinary skill in the art that the functionality of any single computer may be spread across a number of individual machines. Therefore, a computer, as used herein, can refer both to a single standalone machine, or to a number of integrated (e.g. networked) machines which work together to perform the actions ascribed to that computer herein or to a system having discrete parts, but which are connected together to operate in conjunction with each other to perform those same actions.

Each such computer discussed herein will also include hardware and/or software allowing access to the Internet or other network (16) by any mechanism currently known or later discovered including, but not limited to, through a modem and phone line, a Digital Subscriber Line (DSL) connection, a cable modem, a T1 or T10 high speed connection, a wireless connection, or any other connection. Generally, Internet (16) service will be provided by an Internet Service Provider (ISP). This communication software and hardware may be provided standard with the computer, may have been added for other reasons, or may be provided as part of an embodiment of the system described herein.

The term “software” as used herein refers to code objects, logic, command structures, or other instructions written in any language and executable in any environment designed to be executed by or on a computer. It should be recognized that software functionality can be hardwired onto a chip or into other hardware while still considering it software within the meaning of this disclosure.

The software will preferably be installed on a hard drive or other memory device or computer readable memory associated with or accessible by the computer so that the software can be executed by the computer via the series of computer readable instructions. It is preferred that the software be operable in a standard operating environment (such as, but not limited to, Windows™, MacOS™, Unix™, or Linux™-based operating systems) and it is more preferred that software allowing communication between user and server computers comprise known Internet operating systems including known server software and client software operating in accordance with known standard. This includes, but is not limited to, Internet browsers utilizing hypertext transfer protocol (http).

Any number of remote users (12) may exist in secure computer network (10). Server (14) may reside on one or more server machines coupled to a secure database (18) as shown in FIG. 2, which may comprise mass storage devices, such as magnetic, organic, biological or optical storage based disks, collection pools, tapes, hard drives, or any other computer memory device as known now or later discovered.

In order to allow for information to be provided as part of the service request and offer, it is generally be desirable that the communication between the user computers (12) and the server (14) be in the form of a generally accepted secure communication. That is, that the communication provide for a reasonable expectation of privacy. In a number of service industries, this expectation of privacy is necessary to have any meaningful exchange. While the need for privacy in legal and medical services should be immediately apparent, it can also be necessary in other industries.

For the purpose of providing a reasonable expectation of privacy for communications between remote user (12) and server (14), an embodiment of the secure computer network (10) uses a security module including an authentication mechanism (20) and an encryption mechanism (22) and indicated generally by the block diagram of FIG. 2. For example, authentication mechanism (20) may include a security layer such Transport Layer Security (TLS) or Secure Socket Layer (SSL) (referred to as “TLS/SSL”) which identifies server (14) and remote user (12) using X.509 certificates. After the identity of server (14) and remote user (12) has been validated an encryption scheme (22) is exchanged that meets or exceeds current industry standards for VPN (using IP sec/SSL or TLS), EV SSL, SSL, TLS, https or a firewall including suitable software and hardware configurations. It will be understood that other encryption schemes and authentication processes may be used so long as they provide a reasonable expectation of privacy for communication between remote user (12) and server (14).

In an embodiment of the system. The arrangement of FIG. 2 will be utilized both by consumers (112) and vendors (212) which will each act as the remote user (12) of FIG. 2 when interacting with the server (14). Each will respectively, for example, be enabled to communicate over the Internet securely with a reasonable expectation of privacy by establishing a Virtual Private Network (VPN) through use of (EVSSL) (22) whereby: The end user (12) connects to Internet (16) through use of a user computer; The user computer connects to the web server machine (20) and certificate for that machine (20) is sent to the end-user; The end user (12) then connects to CA-Certificate Authority (66) and receives and a validation certificate which is validated against the prior certificate the user obtain when initially connecting to the secure server machine (20); Once the user's certificate is validated (12) the end user is allowed to connect to the secure machine network (20); A VPN connection is established between the end user (12) and secure server (20) site allowing the user a reasonable expectation of privacy while using the secure server site. Thus, all the users (112) and (212) are connected to the server securely as indicated in FIG. 1.

For the remainder of this document, communications between users (12) utilizing the server (14) will be discussed. Therefore, this document will discuss communications from vendors (212) and consumers (112) as contemplated by FIG. 1 recognizing that, each of the vendors (212) and consumers (112) will generally comprise a user with a computer (12) as discussed above with the server (14) with regards to their specific communications in FIG. 2. However, their role in the offer and acceptance components of the present system (10) will generally be different and, therefore, it is best to discuss them in terms of their roles.

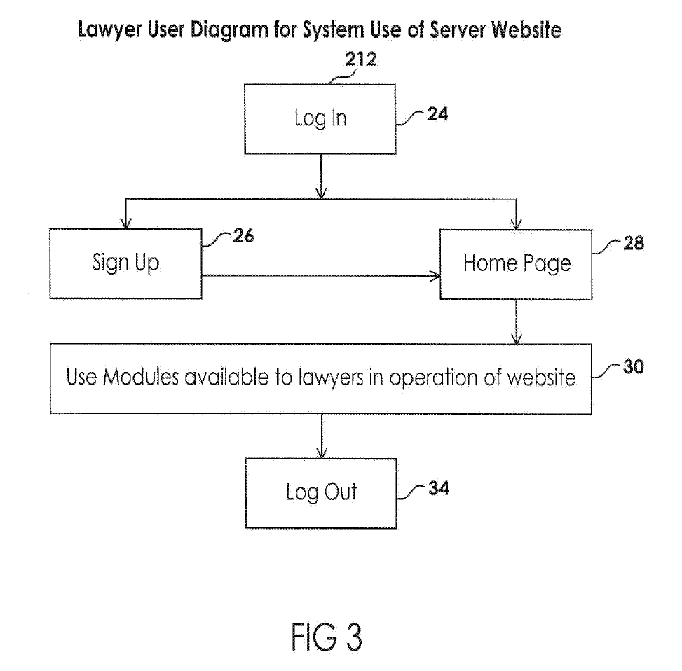

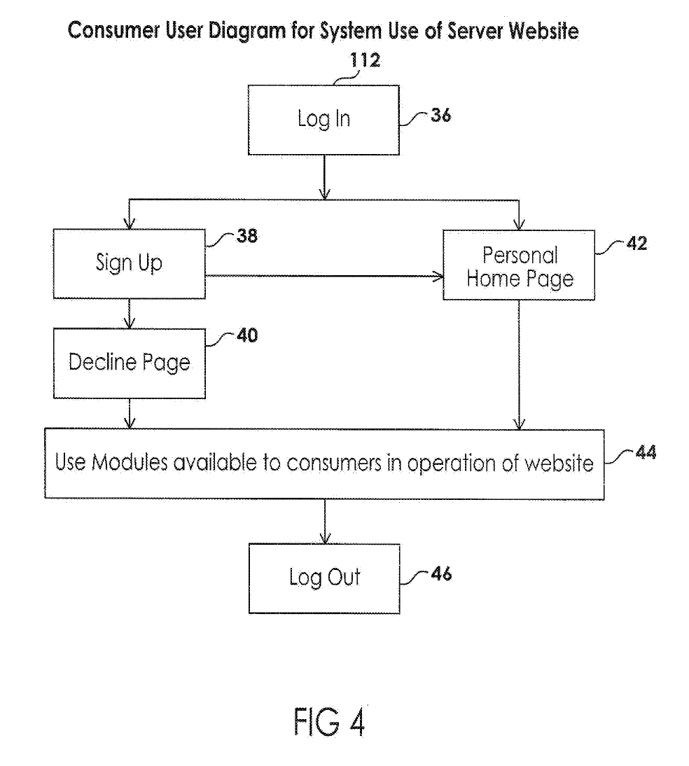

As shown in the embodiments of FIGS. 3 and 4 respectively, remote user (212) is a vendor and remote user (112) is a consumer (i.e., a potential client), respectively. Making use of secure computer network (10), vendor (212) may quote fees prior to a client's request for a quoted offer. In the examples generally discussed herein the vendor (212) will be presumed to be an attorney providing legal services for a contingency fee while the consumer (112) is a party looking for legal representation in a particular type of case which is commonly taken on a contingency fee and in which the vendor (212) is able to represent the consumer (112). It will be understood, however, that secure computer network (10) may be used by other vendor parties in any service industry. For example, realtors, auctioneers, tradesmen, bricklayers, doctors, and the like can also use the system quoting fees and costs and making offers prior to a consumer's inquiry.

Although the system can be used by many different professions as vendors, with continuing reference to the embodiment of FIG. 3, as mentioned above, vendor (212) is an attorney. In step (24), attorney (212) logs onto server (14) and signs in initiating the secure communication. In step (26), attorney (212) enters personal information including his name, address, years of practice, types of cases that he will take, the geographic areas from which the vendor desires to obtain business and his rate charge for such work expressed as hourly, flat fee, blocks of hours, bulk-hourly or contingency. In effect, these are the components of his indications of cost and they may be absolute (e.g. 33% in all cases) or may be variable (e.g. 33%+1% for every 100 miles away that the court the trial will be held in is located and −1% for every ten million dollars above fifty million the case is worth).

In step (28), he can create a home page which may include photographs, videos and such other information as he wants to display. Effectively, this entry in step (28) allows him to provide more standard marketing material as part of his offer and is intended to act as part of the quality determination by the consumer. In step (30) he may use those modules available to attorneys on server (14), one of which is a recovery calculation module (32) as described below in order to compute different rates and to enter his desired service fees. In step (34) the vendor (212) logs out.

After entry of the information, the server (14) is now able to provide offers on his behalf based on his rate entry information and to automatically adjust the offer based on his variables. This can include excluding the vendor (212) from making an offer in certain cases where s/he has indicated that s/he does not wish to make offers. For example, the vendor (212) may provide rates for automobile accident and divorce cases, but indicate to the system not to make offers in criminal matters as s/he does not handle that type of work. Similar the vendor (212) may not be authorized to practice in certain states or courts.

In FIG. 4, remote user is a consumer (112) or in the eyes of vendor (212), a potential legal client. In step ((36)), consumer (12) logs in and in step (38) signs up and enters personal and information related to the service they wish. In the case of legal representation, this may include the type of case (e.g. is it a traffic matter, criminal matter, etc.) as well as the jurisdiction of the potential suit or where the consumer resides.

As consumers may not be familiar with legal terms such as “jurisdiction” in order for them to accurately determine where the case would be tried, the system may request the information utilizing a “plain English” guided questionnaire. The system, may then automatically interpret the information provided in the answers in order to more specifically define what the specifics are. If an answer does not provide necessary information to the system, or does not make sense in the context, the system may request another answer or may continue to provide guided questions to try and resolve the issue.

In an embodiment, the consumer may decline (40) to enter information about their specific service request and may only enter general information, or no information at all. While this will generally provide a more generalized set of offers, it can allow a consumer to obtain more broad reaching information or to avoid having to enter personal information if they are uncomfortable doing so. In step (42) consumer may create a personal home page, in step (44) uses such modules as are available to consumers on server (14) (including the recovery calculation module (32) mentioned above) and in step (46) logs out. The information entered by vendor (212) and consumer (112) is securely stored in database (18) on server (14).

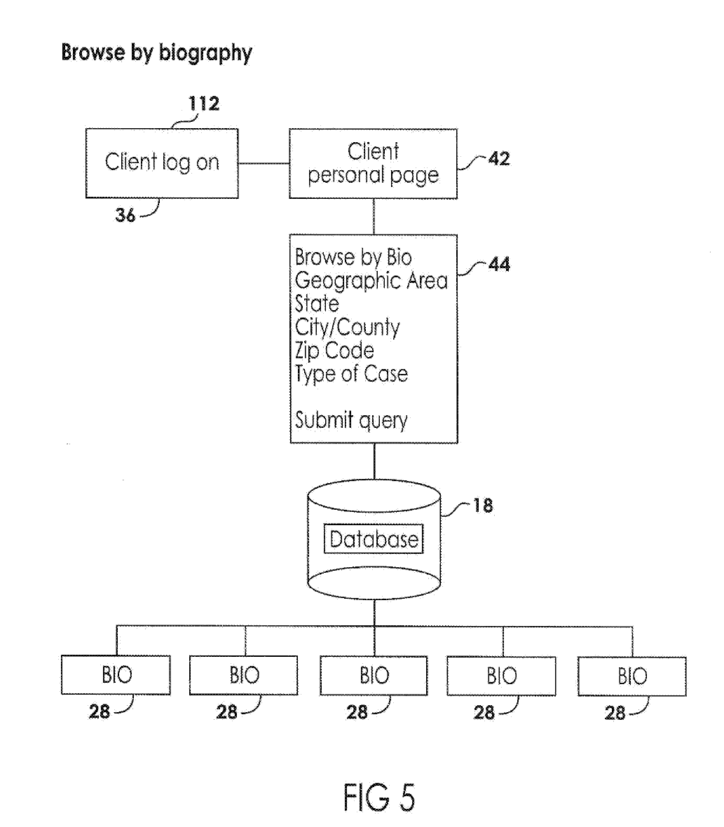

Use of the system by consumer (112) in order to obtain offers for a particular service is shown in FIG. 5. After logging in (36) consumer (12) goes to his home page (42) and from there may use module (30) on server (14) to browse the attorneys listed on server (14) by biography taken from their home pages (28). He may also enter a query regarding a legal matter including information about the state, county, zip code, geographic area or city where the matter arises, or where the consumer resides, the type of case, or other variable information. This may be information from the case provided when the account is set up, or the consumer (112) may enter new information. It is important to recognize that the information entered by both the consumer and vendor is very industry specific.

Thus, in a legal example, while items such as the nature of the suit and the location of the presiding judge may be taken into account, these may be meaningless to a real estate or auctioneering transaction where different variables are used. Thus, this disclosure does not get into great details as to the specifics used in calculation of the offer and the necessary service, but refers to them generally as “variables” or “information”.

In an example, the consumer (112) may enter information concerning an auto vehicle accident that occurred in Missouri and queried database (18) through module (30) for those vendors (212) (attorneys) who have indicated an interest in taking a case of an automobile accident involving claimants from certain geographic areas (namely Missouri) on a contingency fee. The system will then take in these variables, compare them against the vendors in the system, and generate a list of vendors (212) who are willing to perform the services and their indicated “default” fee for doing so. This list is called an offer report.

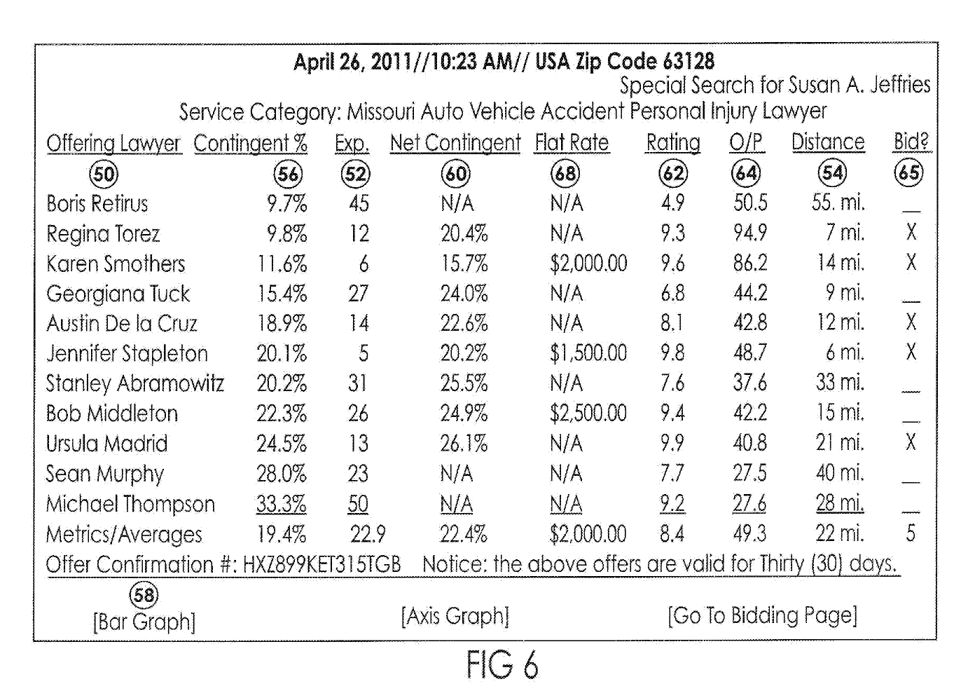

The offer report, reflected in FIG. 6, provides a list (50) of attorneys whose entered variable indicate that they are willing to take a case of this type together with information regarding their years of practice (52), distance from client (54) (calculated by one of the modules in server (14)), a net contingent fee rate (60), and/or quoted contingent fee rate (56) for such a matter. In effect, the offer report includes price information (the fee rates (60) and (56)) as well as easy access to information that may be useful in determining quality and value (the experience (52), distance (54) and access to their homepage (28)).

This material is all drawn from the information originally entered by the vendors and the specific values provided will generally all be calculated based on the specifics of the case and variables that the attorney has entered. For example, an attorney may provide for a different contingency fee for different jurisdictions (such as, but not limited to, because they feel cases in those jurisdictions are easier or harder, because the jurisdiction is further from the attorney's principle office, or simply because an attorney does not like taking cases in that jurisdiction). Further, the information will be dynamically generated and therefore the information may take into account competitive offerings made in the same offer report and utilize systems such as that disclosed in U.S. Provisional Application Ser. No. 61/555,371 in order to dynamically determine the specific offer price.

As the report is generally a dynamically generated document where the specifics of each vendor's service offer are dependent on the current information the server (14) has access to, specifics of the consumers service request and its interaction with that vendor information, and interactions between vendors themselves, the report will generally be date stamped and may include an offer confirmation number (58) which serves to confirm that this is a valid offer created by the system and to act as a future identifier. As part of having access to the system, the participating vendors will have agreed (generally via some form of binding contract with the service and system provider) to honor the rate quoted if an engagement agreement is reached with the client within a preset period of time, for example 30 days.

However, the vendor is always capable of declining to perform the service. Thus, after hearing more about the case, if the attorney referred to above does not want to take the case for the fee quoted (for example because it appears more difficult upon learning additional information), he can decline the representation but he cannot quote a higher fee to that respective consumer for that particular matter. This provides a system where it is difficult to bait-and-switch a consumer. A vendor having no intent to perform the service at the agreed rate, has no ability to provide the service at a greater rate. They may only decline the service outright. Thus, the ability of a vendor to provide a low-ball offer which is then raised is generally eliminated.

When the automated offer report of FIG. 6 is generated, the vendors will, in an embodiment, receive notice of the consumer's request for the vendors to participate in an offer auction such as by electronic notice such as, but not limited to, text messaging, email, audio telephonic or other electronic transmission. Thus, the vendors are all aware that they have appeared on an offer report. Further, it will generally be the case that a vendor (212) on the offer report will have access to the same offer report via the identification number (58). Vendors (212) may also be provided with this information even if there is no request for an offer auction in order to enhance competitive pricing between vendors through free flow of information.

In the embodiment of FIG. 6, the offer report includes additional information that the consumer can use in an initial computation of value. For example, a column (62) is included with the attorney's rating based on the experience of other consumers. This may be provided via a known rating service such as Angie's List, or may be part of the present system. In an embodiment, there is also provided a quotient (64) (Q/P) representative of value (i.e., value is the ratio combination of price and quality, in the context of services, or quantity in the context of goods, products and commodities) and one measure of value is calculated by dividing the respective attorney's rating (or Net Fee rate if offered) by that attorney vendor's contingency fee rate. For other service-vendors (i.e. plastic surgeons, accountants, excavators or computer programmers to name a few) and service-combined-with-product vendors (i.e. masonry contractors, portrait artists, computer chip designer-manufacturers or funeral directors to name a few), the same ratio is obtained by dividing a vendor's rating by a vendor's respective cost or rate to produce an objective value which the consumer can measure against the consumer's unique subjective requirements.

With continuing reference to FIG. 6, consumer (112) may request that vendors (212) reconsider their quote offers (65) based on additional information which the client provides through secure computer network (10). In those cases of clear liability or enormous medical bills, an attorney may be willing to quote a lower Net Fee (60) based on an application of the third and fourth method math formulas listed herein through use of the recovery calculation module (32) described below.

As should be apparent, the offer report provides an initial comparison of services which has not previously be available. Further, in an embodiment, the offer report is provided as an interactive electronic documents and FIG. 6 therefore shows a screen shot. Thus, a consumer may review these and determine which vendor to contact. Further, since the vendor is contractually bound by the offer provided on the offer report (unless they turn down providing the services totally), the system provides for competitive offering.

Further, as indicated on the reconsideration, the consumer may indicate (65) in such an interactive system that they are requesting a further competitive bid on the services from multiple vendors (212). As indicated above, this system allows for vendors (212) to revise their offers when provided with additional information. In an embodiment, as the vendors (212) can each see the same offer report, they know where they stand in the bidding. Based on this, a vendor (212) which feels that they are likely to lose the work, but can adjust their price down, may do so to become more competitive. Similarly, as more facts are provided, a vendor (212) may discover they have unique expertise in this area and may revise their rate accordingly. This provides the consumer with generally improved offerings where the value offered between more of the vendors (212) is likely closer. This request for revised offers is called an offer auction (65)

Within the context of a consumer requesting an offer auction (65), the offer auction (65) will be used by the consumer (112) who enters specific case or situational facts in the secure database (18) and requests either the specific vendors (212) the consumer (112) selected in the interactive offer report (65) and/or vendors (212) who have previously indicated in the secure data base a request to participate in offer auctions for cases or work of a certain type related to a certain geographic area. The consumer user (112) indicates the nature and scope of what type of work the consumer (112) needs performed by using dropdown menus, open fields, buttons offering choices, text boxes and other information gathering technologies presently in use and those yet to be developed for communicating over the Internet, the combination of which will depend on the type of work to be performed. The important item to note is that this information will generally go beyond the basic information originally provided so that specifics of the case or service are provided which were not taken into account in generating the initial offer report.

The consumer (112) will be entering this confidential information relying on a reasonable expectation of privacy because the consumer user (112) might be entering trade secrets, confidential, sensitive, privileged or private specific case or situational facts in the secure computer network data base (18). After the consumer (112) indicates that s/he has provided sufficient information, the vendor user (212) is notified electronically of the consumer user (112) requesting vendor user (212) to review the consumer user's (112) case facts or situation needing work performed in order to cause the vendor user (212) to make a revised offer of a competitive fee or rate in relation to the specific case or situation facts entered by the consumer user (112). After a preset period of time, bidding by vendors closes and offers on the revised offer report generated therefrom are frozen.

In an embodiment, at this stage, after the offer auction (65) has closed, the consumer (12) is not yet allowed to view the identities of the participants and their respective bids, except for the identity of the vendor (212) who entered the lowest bid at close of the offer auction. A convenient link or path to the biography page(s) or video of the lowest bidding vendor is provided to the consumer (112). After the consumer (112) views the biography page(s) or views the video of the lowest vendor bidder, the consumer (112) is allowed to view the full results of the report, including the respective identities and bids of the vendors who participated in the offer auction. In this way, the lowest bidder is provided a slight advantage in obtaining the business and therefore there is incentive to lower bids.

The offer auction report is generally similar to the original offer report of FIG. 6 and contains a column(s) for the vendors names serving as links to biography page(s) for vendors, a column(s) for either Contingent Fee Rate, Net Contingent Fee Rate, Hourly Fee Rate or Flat Fee, the type of which is presented is initially requested by the consumer (112) prior to the beginning of the offer auction. Spaces for additional information may also be provided depending on the nature of the services and the offer auction. The consumer user (112) and vendor user (212) may then choose to download and print out either report to be used as in-hand reference to follow up in contacting and interviewing different vendors. In an additional, paperless alternative, the consumer user (112) and vendor user (212) may also retrieve the reports, which reports have been stored on the secure database (18), through use of the secure computer machine network (10) by applying the unique alpha-numeric identifier assigned to such reports as a convenient storage, reference and retrieval tool for both consumer user (112) and vendor user (212). The reports may also be stored in a permanent record for utilization in ensuring vendor (212) compliance with rules.

Such as those discussed in U.S. Provisional Application Ser. No. 61/555,374, an online contracting system may be combined with the present system in order to allow the contract to be consummated electronically. In this way, the offer can be turned into a contract without the need for a physical meeting. The secure system may also allow vendors (212) to meet potential consumers (112) at the consumers' (112) discretion via a virtual interface such as, but not limited to, secure video or text in order to make further reductions of fee quoted offers or to discuss specifics of the consumer user's needs. However, alternative embodiments of the system contemplate that the final arrangement between the parties would be performed utilizing standard face to face techniques and formal offer acceptance procedures as is already done in the respective industries. In this way any ethical, notice, or related concerns may be addressed in accordance with rules that are already well established.

If contract is made between vendor (212) and consumer (112) based on either report, and subject to any privacy concerns of the consumer (112), notice may be given to server (14) by the vendor and, after the case ends, a report as to the quality of the representation is made possible to be solicited from consumer (112).

It should be recognized that in many cases the ability to specify a price could result in abuse by certain vendors by how they calculate the price and by trying to utilize tactics in their price setting which provide a different price calculation metric than others. As service offers generally involve some uncertainty, the vendors (212) could choose to provide an offer that allows for adjustment of the resultant price if certain, relatively likely, conditions prove to be the case. In order to minimize this, it is generally preferred that the prices be provided in accordance with a fixed set of criteria. For example, for a bricklaying service, the price can be by foot or for the entire specified job. For something such as contingency fee legal services, this can be more difficult as the calculation may necessarily involve other factors.

Many contingent fee legal clients do not understand the way in which the client's portion of a recovered amount will be calculated even though the calculation is described in an engagement letter or contract with vendor. “Net contingency rate” (NCFR) and “contingency rate” (CFR) are defined as part of math formulas described herein and are indicated to be calculated using these formulas as part of an embodiment of the system when used with attorneys. As described below there are four commonly used mathematic methods used to calculate personal injury attorney fees and client recoveries as follows:

### First Method—Standard Contingent Legal Fee Formula

RA−[(RA×CFR)+litigation costs]=Client recovery subject to medical bill liens

### Second Method—Prior Settlement Offer Situation Applying Standard Contingent Legal Fee Formula

RA−[((RA−Prior Offer)×CFR)+Litigation Costs]=Client recovery subject to medical bill liens

### Third Method—Net Fee Rate Legal Fee Formula

RA−[NCFR×(RA−Specials)+Litigation Costs)]=Client recovery subject to medical bill liens

### Fourth Method—Prior Offer Situation Applying Net Fee Rate Legal Fee Formula

RA−[NCFR×(RA−(Specials+PSO))+Litigation Costs]=Client recovery subject to medical bill liens

### Where:

RA=Client's Portion of a Recovered Amount obtained by settlement, judgment, arbitration or other legal means:

CFR=Contingent Fee Rate: Expressed as a percentage

NCFR=Net Contingent Fee Rate (NCFR): Expressed as a percentage

Litigation Costs=Attorney Expenses incurred directly associated with representing client in the course of collecting evidence in support of client's claim and which costs are to be reimbursed to the attorney out of monies recovered on behalf of client.

Specials=The sum of a Client's medical bills, lost wages, and other expenses incurred by the client as a proximate cause of the claimed injury(s).

PSO=Prior Settlement Offer, the value of any Settlement Offer made to the injured client prior to the client hiring subject attorney

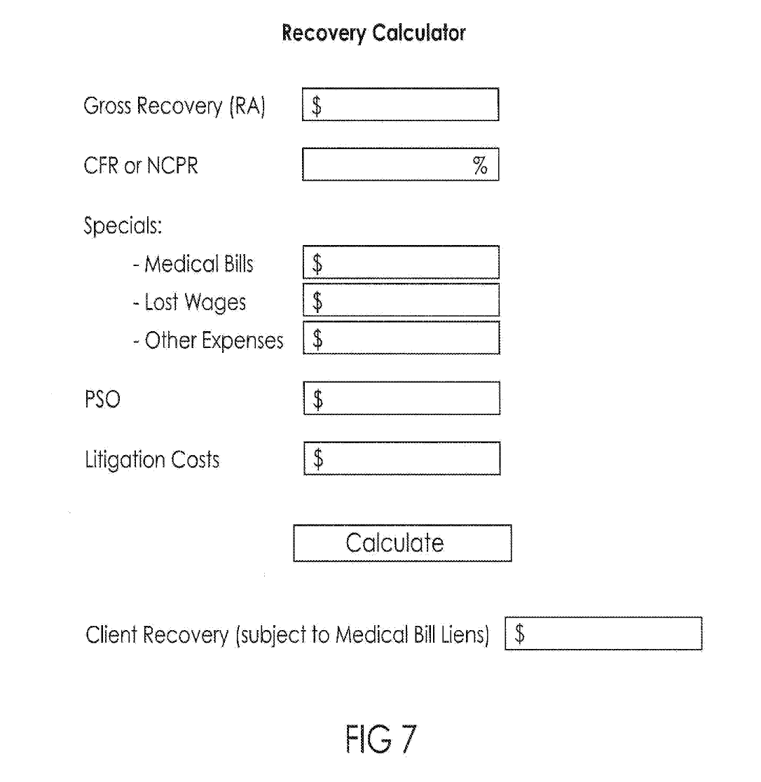

As part of the consumer modules (44) the server (14) may include a recovery calculation module (32) which is programmed such that the client's portion of the recovered amount can be calculated using any one (or all) of the formulas discussed above. Thus, the client can determine, based on the various offers, which they think may be the best fee methodology given their expected situation. FIG. 7 is a screen shot of a page for data entry concerning a hypothetical gross recovery, contingent fee rate or net contingent fee rate, etc. for use with module (32). An attorney can also use recovery calculation module (32) to determine what contingent fee to quote or any other unfilled field based on the figures entered into the remaining fields of FIG. 7. By providing such a fixed formula calculation, the ability of a vendor to utilize a mathematical calculation which is potentially deceiving can be reduced as the consumer can reverse out the numbers and can potentially detect that an offer is not as good as it appears.

While the method and system have been discussed at length in connection of personal injury legal service providers and clients in need of such representation, it will be apparent that the method and system can be adapted to other commission fee service providers and to vendors of products that include services, the costs of which are not usually published and which can be made more competitive.

It should be recognized that in alternative embodiments, server (14) may contain a number of other modules which may be useful for certain services or service providers. These include, but not are limited to: Client Medical Records Procurement; A forum for posting requests for proposal of attorney block hourly rates in a locale pursuant to specifications and allowing a secure, confidential Internet connection through which vendor and consumer can determine specifics required; Due diligence queries; A secure court document filing system; A Secure Certified Digital Document Storage and Retrieval System (SCDDSRS); System for financing different aspects of consumer users, cases or projects; A depository of different documents that can be shared by vendor members as a convenient resource tool; A convenient and secure forum where lawyers can securely communicate with potential and established financiers of different cases for litigation expenses or law practice operations so as to keep client matters or law office practices privileged and confidential; Other modules can be used for the exchange or swapping of information which may be provided to increase the convenience and value of the secure computer network machine site to the consumer and vendor.

Interaction with these modules by users (12) is made practical by secure computer network (10) as it provides an expectation of privacy for the exchange of confidential or privileged information, disclosure of which would otherwise be discouraged due to the insecure nature of Internet transmissions and the contractual or sworn duty of confidence owed by vendor users (12) to consumer users (12).

A number of streams of revenue can be created in a number of different ways for the operation of the system. For example, when vendors (212) initially register, the vendors (212) may agree to and pay all or a part of a membership fee. The vendors (212) may also be billed for the unique, individual displays of web-pages of information requested by consumers (112), which include some information about the vendors (212) creating a billable event for each member vendor (212) whose information is displayed on a respective web-page, which was requested by consumer (112) users. Alternatively or additionally, charges will also be made for the vendors (212) use of certain on-line tools such as secure video conferencing, secure medical records procurement, display of a vendor's video amongst other functions and tools offered by the system (10) to make respective vendors (212) ability to conduct business more convenient and efficient for vendors (212) and/or consumers (112).

Electronic ads can also generate significant revenue by use of this secure system in that ads will be seen by humans and not subject to generating a “false billing” because the site will be secure and protected from visits by search engine devices, bots and protocols which tend to generate the illusion that on-line ads have been viewed by humans when in reality they were not.

Billable events may also occur every time a consumer (112) views a different page of a vendor (212) and the charge for such views can and will vary according to the laws of supply and demand. The vendors (212) may have the ability to specify how many page views, videos or other billable events they wish to pay for in each billing cycle in order to allow individual vendors (212) to customize their advertising and stay within a budget. The secure system will allow vendors (212) to build biography pages and other advertising pages with templates and other object oriented software for a nominal charge or the vendors (212) can have the system administrators build and design such pages for the vendor (212) at an additional cost. The operation of the system will provide additional streams of revenue that are not yet exactly known but shall be incorporated into the system.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A computerized method of matching service vendors to consumers seeking services, the method comprising:
providing a computer server having access to a secure database and accessible via a computer network;
securely connecting a plurality of vendors to said network to allow said vendors to provide vendor information which may be used to form an offer by each vendor to provide certain services, said vendor information being changeable on the secure database by the providing vendor at any time;
securely connecting a consumer to the network for requesting a desired service; and
said server generating an offer report based on said desired service and said vendor information, said offer report comprising a plurality of offers of services by at least one of said vendors;
wherein said offer report is date stamped, identifies each of said at least one vendors, and provides a price for the desired service;
wherein said price is specific to said desired service of said consumer; and
wherein each of said vendors listed in said offer report is bound, as a condition to being allowed to access said server, that each of said vendors will provide the desired service for no more than said price or will decline to provide said desired service.

2. The method of claim 1 wherein the vendor must make contract with said consumer or decline within a preset period of time.

3. The method of claim 1 wherein said server provides said offer report to all said vendors identified in the report for competitive review of the offers therein.

4. The method of claim 1 further comprising:
allowing the consumer to select at least one vendor in said offer report; and
said server providing said offer report to all said selected vendors to allow each of said selected vendors to provide a new competitive offer.

5. The method of claim 4 wherein said consumer provides additional information about the desired service to said selected vendors.

6. The method of claim 4 wherein said consumer can select one of said new competitive offers and contract with said vendor providing said offer via said server.

7. A system of matching service vendors to consumers seeking services comprising:
a computer server accessible via a computer network;
a secure connection between said server and a plurality of vendors over said network to allow said vendors to provide vendor information to said server which may be used to form an offer by each vendor to provide certain services; said vendor information being changeable on a secure database associated with said secure server by the providing vendor at any time; and
a secure connection between said server and a consumer over the network allowing said consumer to indicate a desired service;
wherein said server generates an offer report based on said desired service and said vendor information, said offer report comprising a plurality of offers of services by at least one of said vendors and provides access to said offer report to said consumer;
wherein said offer report is date stamped, identifies each of said at least one vendors, and provides a price for the desired service;
wherein said price is specific to said desired service of said consumer; and
wherein each of said vendors listed in said offer report is bound, as a condition to being allowed to access said server, that each of said vendors will provide the desired service for no more than said price or will decline to provide said desired service.

8. The system of claim 1 wherein the vendor must make contract with said consumer or decline within a preset period of time.

9. The system of claim 1 wherein said server provides said offer report to all said vendors identified in the report for competitive review of the offers therein.

10. The system of claim 1 wherein after said offer report is provided said system:
allows the consumer to select at least one vendor in said offer report;
said server provides said offer report to all said selected vendors to allow each of said selected vendors to provide a new competitive offer; and
said server allows access to said new competitive offers to said consumer.

11. The system of claim 10 wherein said consumer provides additional information about the desired service to said selected vendors.

12. The system of claim 10 wherein said consumer can select one of said new competitive offers and contract with said vendor providing said offer via said server.

13. A non-transitory computer readable memory comprising:
computer readable instructions for providing a computer server having access to a secure database and accessible via a computer network;
computer readable instructions for securely connecting a plurality of vendors to said network to allow said vendors to provide vendor information which may be used to form an offer by each vendor to provide certain services; said vendor information being changeable on the secure database by the providing vendor at any time;
computer readable instructions for securely connecting a consumer to the network for requesting a desired service; and
computer readable instructions for said server generating an offer report based on said desired service and said vendor information, said offer report comprising a plurality of offers of services by at least one of said vendors;
wherein said offer report is date stamped, identifies each of said at least one vendors, and provides a price for the desired service;
wherein said price is specific to said desired service of said consumer; and
wherein each of said vendors listed in said offer report is bound, as a condition to being allowed to access said server, that each of said vendors will provide the desired service for no more than said price or will decline to provide said desired service.
